(19) United States
(12) Patent Application Publication
(10) Pub. No.: US 2007/0021014 A1
(43) Pub. Date: Jan. 25, 2007

(54) Method of removing a connector and a removing tool for removing a connector

(75) Inventor: Takashi Fukuda, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/256,969

(22) Filed: Oct. 25, 2005

(30) Foreign Application Priority Data
Jul. 22, 2005 (JP) 2005-212541

(51) Int. Cl. H01R 4/02

(52) U.S. Cl. 439/876

(57) ABSTRACT

A connector, which is mounted on a board by applying a solder to terminal leads extending from a connector body, is removed from the board. A heat transfer part is inserted into and attached to the connector. The terminal leads are heated by heating the heat transfer part and melting the solder by heat. Then, the connector is separated from the connector from the board.

### BACKGROUND OF THE INVENTION

1. Field of the Invention

The present invention generally relates to a method of removing a connector and a removing tool for removing a connector and, more particularly, to a method of removing a connector and a tool for removing a connector that are suitable for repairing a connector that is soldered to a substrate on which electronic parts are mounted in high-density.

2. Description of the Related Art

In recent years, achieving high performance and high density mounting has been attempted for parts mounted on a printed wiring board. Additionally, diversification (increasing or decreasing in a size) of parts has been advanced. Thus, an interval between the mounted parts has been decreased more and more. A connector is always mounted on a print wiring board so as to achieve an interface with external units (including a memory). Since such a connecter is mounted with a small interval due such high density mounting, it has become very difficult for a connector to be replaced when part replacement is needed.

Conventionally, a rework of a connector is performed by melting a solder on an individual terminal lead basis using a heat conductive soldering-iron heating method (for example, refer to Patent Documents 1 to 3). The heat conductive soldering-iron heating method is an example used for a connector of a surface-mount type, where a tip of a soldering iron is brought into contact with each soldered portion in a row of leads while heating the tip of the soldering iron at a predetermined temperature so as to melt the solder, thereby performing a rework of the connector.

FIG. 1 shows a method of removing a connecter according the heat conductive soldering-iron heating method. In the example shown in FIG. 1, three connectors 2 are surface-mounted on a board 1. Each of the connectors 2 comprises a connector body 3 and terminal leads 4.

The connector body 3 is made by resin molding, and a plug insertion hole 5 is formed in the center thereof so that a plug (not shown in the figure) is inserted into the plug insertion hole 5. The terminal leads 4, each of which has an L-shape, are symmetrically arranged on both sides of the plug insertion hole 5. Additionally, a portion of each terminal lead 4 extending on a bottom part of the connector body 3 toward a side is electrically and mechanically connected to a terminal pattern of the board 1 by a solder 6.

Thus, in order to remove the connectors 2, which are surface-mounted on the board 1, a soldering iron 7 is used as shown in FIG. 1 to melt the solder 6 by bringing the tip of the soldering iron 7 into contact with the solder 6 and separating each of the connectors 2 from the board 1.

Patent Document 1: Japanese Laid-Open Patent Application No. 58-093566

Patent Document 2: Japanese Laid-Open Patent Application No. 62-20397

Patent Document 3: Japanese Laid-Open Patent Application No. 2001-274543

However, according to the conventional removing method, there is a problem that when the connector 2 is large, it is difficult to sufficiently heat the soldering iron 6 and the terminal lead 4 even if the soldering iron 7 has a large capacity. Additionally, when the mounting density of the connectors 2 is high and a pitch between the adjacent connectors 2 or between the connector 2 and an electronic part is small, there is a problem that it is difficult or impossible to reserve a space for accessing the soldering iron 7 to the terminal lead 4 or the solder 6.

Further, if it is narrow pitch mounting where, for example, 200 pieces of the terminal leads 4 are arranged at a pitch of 1 mm, it is necessary to bring the tip of the soldering iron 7 into the solders 6 many times within an extremely small range, however, it is difficult to perform such an operation and it takes time and labor to perform the rework operation.

### SUMMARY OF THE INVENTION

It is a general object of the present invention to provide an improved and useful method of removing a connector and removing tool for removing a connector.

A more specific object of the present invention is to provide a method of removing a connector and a removing tool for removing a connector, which is capable of removing a connector mounted on a board without giving influences to other electronic parts while high-density mounting of electronic parts is performed on the board.

In order to achieve the above-mentioned objects, there is provided according to one aspect of the present invention a method of removing a connector, which is mounted on a board, from the board by applying a solder to terminal leads extending from a connector body, the method comprising: a step of attaching a heat transfer part to the connector by insertion; a step of heating the terminal leads by heating the heat transfer part and melting the solder by heat; and a step of separating said connector from the board.

According to the above-mentioned invention, the heat transfer part is inserted into and attached to the connector, and the heat transfer part is heated so as to heat the terminal leads, thereby melting the solder. Accordingly, when separating the connector from the board, there is no need to contact a soldering iron to a soldered portion, and there is no need to reserve a contact area for a soldering iron to remove the connector from the board. Thus, electronic parts including the connector can be mounted to the board at a high-density.

It should be noted that the above-mentioned method of removing a connector is applicable to both a connector surface-mounted to a board and a connector insertion-mounted to a board.

Additionally, there is provided according to another aspect of the present invention a removing tool used for removing a connector from a board, the connector being mounted to the board by soldering lead terminals extending from a connector body, the removing tool comprising: a heat transfer part having a thermal conductivity and being inserted into and attached to the connector body; and a heating device that heats the heat transfer part.

According to the above-mentioned invention, the heat transfer part having a thermal conductivity is inserted into and attached to the connector body. Accordingly, the terminal leads are heated from inside the connector by heating the heat transfer part by the heating device. Thereby, there is no need to reserve a contact area for a soldering iron for removing the connector on the board. Thus, electronic parts including the connector can be mounted to the board at a high-density.

Other objects, features and advantages of the present invention will become more apparent from the following detailed description when read in conjunction with the accompanying drawings.

### BRIEF DESCRIPTION OF THE DRAWINGS

FIG. 1 is an illustration for explaining a conventional method of removing a connector;

FIG. 2 is an illustration for explaining a part a process according to a method of removing a connector according to an embodiment of the present invention;

FIG. 3 is an illustration for explaining a part the process according to the method of removing a connector according to the embodiment of the present invention;

FIG. 4 is an illustration for explaining a part the process according to the method of removing a connector according to the embodiment of the present invention;

FIG. 5A is a see-through view of a connector used in the method of removing a connector;

FIG. 5B is a perspective view of the connector shown in FIG. 5A;

FIG. 6 is a cutaway view of the connector shown in FIG. 5A

FIG. 7 is an illustration showing a heat transfer part; and

FIG. 8 is a cross-sectional view of a heating device.

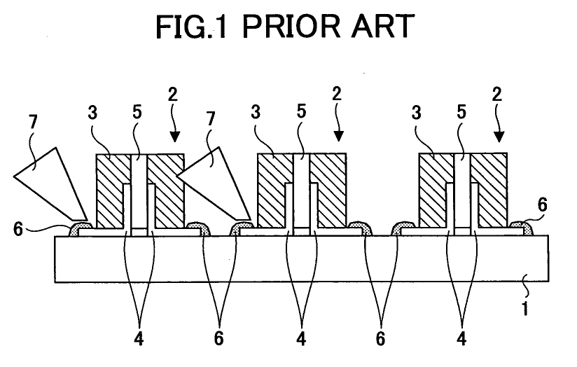

### DETAILED DESCRIPTION OF THE PREFERRED EMBODIMENTS

A description will now be given, with reference to the drawings, of an embodiment of the present invention.

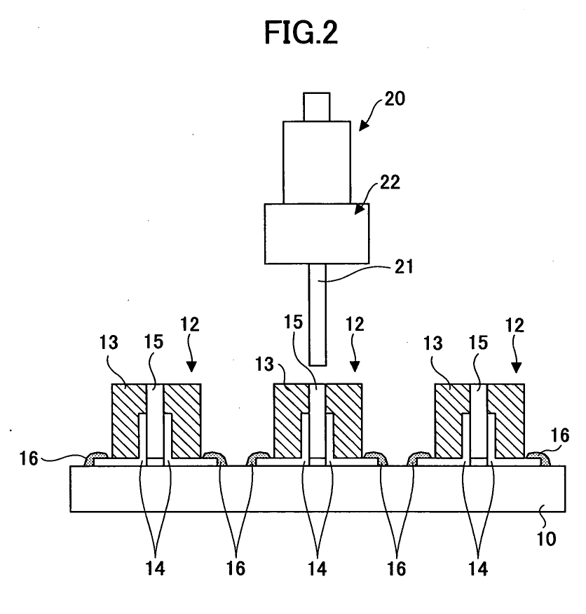

FIG. 2 through FIG. 4 are illustrations for explaining a method of removing a connector according to an embodiment of the present invention. In the present embodiment, a plurality of connectors 12 are surface-mounted on a board 10 at a high density. A description will be given of a method of removing one of the connectors which is located at the center.

The board 1 is, for example, a printed wiring board and a predetermined wiring pattern is formed on a surface thereof. Additionally, a solder resist is applied on the surface of the board 1 but the solder resist is removed from a part where the connectors 12 and other electronic parts are soldered so that portions of the wiring pattern are exposed. Thus, terminal leads 14 of the connectors 12 and other electronic parts are soldered to the wiring pattern of the board 1 using a solder 16.

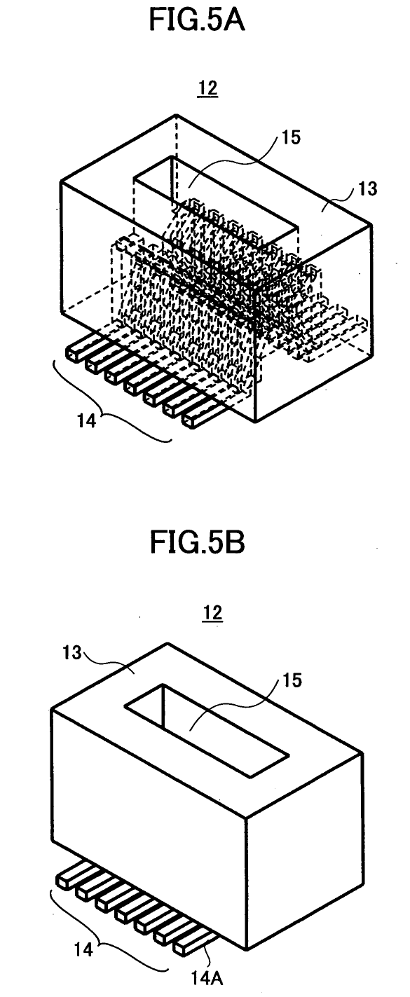

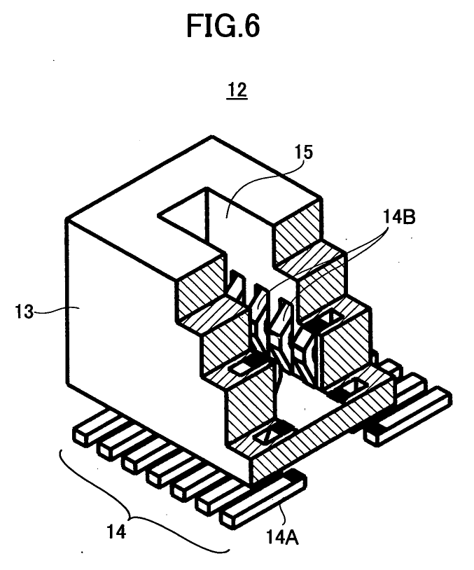

Each of the connectors comprises a connector body 13 and the terminal leads 14 as shown in FIGS. 5A, 5B and 6. The connector body is formed by resin molding, and a plug insertion hole is formed at a central portion thereof so that a plug (not shown in the figure) is inserted into the plug insertion hole 15.

Each terminal lead 14 has an L-shape, and is located symmetrically on both sides of the plug insertion hole 15. Additionally, an extending portion 14A extending on a bottom portion of the connector body 13 toward a side is mechanically and electrically connected to a terminal pattern (not shown in the figure) on the board 10 by solder 16. Thereby, the connectors 12 are surface-mounted on the board 10.

Moreover, a contact portion 14B protruding toward inside the plug insertion hollow 15 is formed in a portion of the terminal lead 14 perpendicularly bent with respect to the extending portion 14 and extending upward. When a plug is inserted into the plug insertion hole 15, the plug is brought into contact with the contact portion 14B, which makes an electrical contact with the contact portion 14B.

A description will now be given of a method of removing the connector 12, which is surface-mounted, from the board 10.

In order to remove the connector 12 from the bard 10, a removing tool 20 shown in FIG. 29 is prepared. The removing tool 20 is constituted generally by a heat transfer part 21 and a heating device 22.

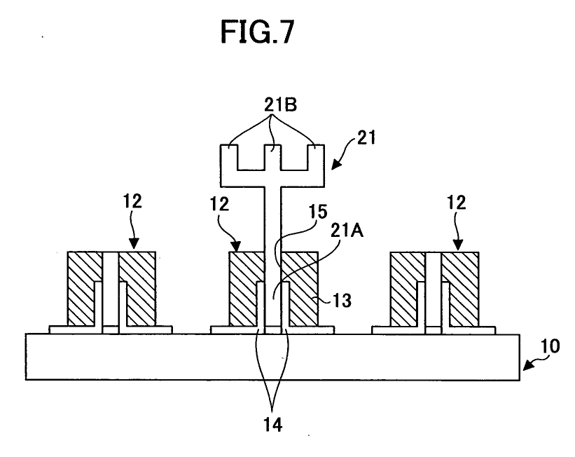

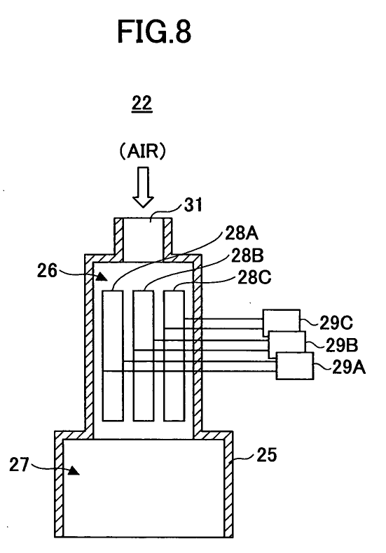

The heat transfer part 21 has a high thermal conductivity, and is constituted by an insertion part 21A and heat-absorption fins 21B as shown in FIG. 7. The insertion part 21A is configured to be inserted into the plug insertion hole 15 formed in the connector body 13 of the connector 12. Additionally, the insertion part 21A is configured to be connected thermally with the contact part 14B in a state where it is inserted into the plug insertion hole 15. Further, the heat-absorption fins 21B (three pieces in the present embodiment) extend from the insertion part 21A.

The heating device 22 is constituted by a heating chamber 26 and a fin attachment chamber 27 formed in a housing 25. A plurality of heaters 28A through 28C (three pieces in the present embodiment) in the heat chamber 26 so that each of the heaters 28A through 28C is capable of controlling a heating temperature. Additionally, the fin attachment part 27 is configured to receive the heat transfer part 21 inserted therein.

Further, an air supply port 31 is provided in an uppermost part of the housing 25, so that air is supplied from an air supply source (not shown in the figure). Accordingly, an air flowing from the air supply port 31 into the housing 25 is heated by the heaters 28A through 28C in the heating chamber 26 and is supplied into the fin attachment chamber 27 in which the heat-absorption fins 21B of the heat transfer part 21 are attached.

Thereby, the heat absorption fins 21B are heated by the high temperature air, and the heat is transferred to the insertion part 21A by heat conduction. At this time, the heating temperature of the heaters 28A through 28A are controlled by controllers 29A through 29C so that the temperature of the insertion part 21A is raised to a temperature which can melt the solder 16 or higher than such a temperature. It should be noted that the air heated the heat absorption fins 21B is exhausted from a lower portion of the fin attachment chamber 27 to outside (hereinafter, this air is referred to exhaust air).

Additionally, as mentioned above in the present embodiment, the plurality of absorption fins 21B are formed in a portion opposite to the side, which is inserted into and attached to the connector body 13 of the heat transfer part 21. Thereby, a heated area to be heated by a high-temperature air is increased, which allows the heater 28 through 28C to efficiently heat the heat transfer part 21. Thus, it can be attempted to reduce an electric power consumed by the removing tool and miniaturize the housing 25.

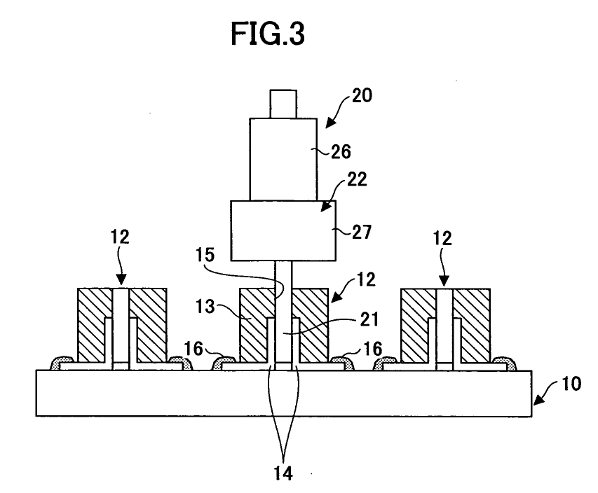

FIG. 3 shows a state where the mounting tool 20 having the above-mentioned structure is attached to the connector 12 by inserting the heat transfer part 21 into the plug insertion hole 15. As mentioned above, the heat transfer part 21 is heated at a temperature to melt the solder 16 or higher that such a temperature. Accordingly, the heat of the heat transfer part 21 is transferred to the terminal leads 14 through the contact portions 14B, which are in contact with the heat transfer part 21 by the heat transfer part 21 being inserted into the plug insertion hole 15.

Then, the heat transferred to the terminal leads 14 is transferred to the extending portions 14A, which are soldered to the board 10. As mentioned above, the temperature of the insertion part 21A is set to a temperature so that the heat at the extending portions 14A can melt the solders 16 in consideration of a specific heat of the terminal leads 14 and a thermal conductivity loss by the connector body 13. Accordingly, the solders 16 are melted by the removing tool 20 and the connector 12 are set in a state where it can be separated from the board 10.

It should be noted that the fin attachment chamber 27 is configured to be separable from the connector 12 in the state where the insertion part 21A is inserted in the plug insertion hole 15. Accordingly, the exhaust air (the air after heating the heat absorption fins 21B) discharged from the lower portion of the fin attachment chamber 27 is not blown directly toward the connector 12. Thus, the connectors 12 other than the connector 12, which is being removed, and the electronic parts mounted in a surrounding area of the connector 12, are positively prevented from being damaged by the high-temperature exhaust air discharged from the removing tool 20.

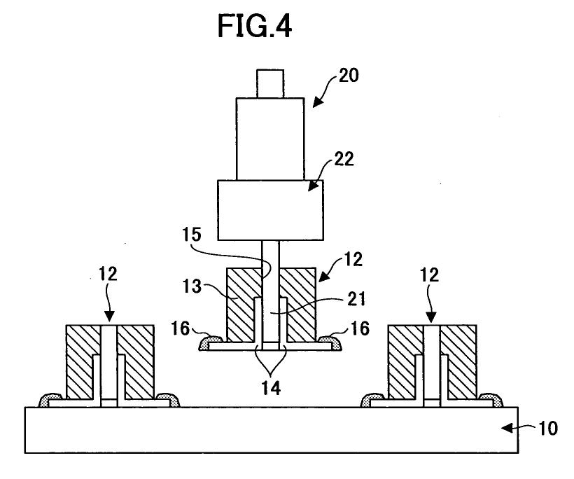

After the solders 16 are melted as mentioned above, the connecter 12 concerned is removed from the board 10, as shown in FIG. 4, by moving the removing tool 20. At this time, since the heat transfer part 21 is inserted in the plug insertion hole 15 of the connector 12, the connector 12 can be removed from the board 10 by moving the removing tool 20.

Thus, according to the removing method according to the present embodiment, there is no need to provide an area for contacting a soldering iron to remove a connector on the board 10 as in the conventional method since the heat transfer part 21 of the removing tool 20 is inserted into and attached to the plug insertion hole 15 of the connector 12 and the terminal leads 14 are heated from inside the connector body 13 by heating the heat transfer part 21. Thereby, by using the removing method according to the present embodiment, electronic parts including the connector 12 can be mounted on the board 10 at a high-density.

Moreover, in the present embodiment, a so-called hot-air heater is used, which heats the supplied air by the heaters 28A through 28C as heating means constituting the removing tool 20. Using the hot-air heater allows to attempt miniaturization of the removing tool 20 and a hot air can be supplied to a wide area of the heat absorption fins 21B, thereby permitting a high-efficiency heating process.

Furthermore, it also becomes possible, according to the ability of attaining the miniaturization of the removal tool 20 as mentioned above, to make the planar shape of the removing tool 20 to be nearly equal to the planar shape of the connector body 13 (connector 12). According to such a structure, when removing the connector 12, the removing tool 20 is prevented from interfering with other electronic parts mounted in the vicinity of the connector. Thereby, it becomes possible to arrange electronic parts in the vicinity of the connector 12, which improves the efficiency of mounting.

It should be noted that although the surface-mounted connector 12 on the board 10 is removed in the above-mentioned embodiment, the present invention is applicable to a method of removing a connector, which is inserted into and mounted to a board, from the board. Additionally, the present invention is applicable to a method of removing an electronic part other than a connector from a board.

The present invention is not limited to the above-mentioned embodiments, and variations and modifications may be made without departing from the scope of the present invention.

The present application is based on Japanese priority application No. 2005-212541 filed Jul. 22, 2005, the entire contents of which are hereby incorporated herein by reference.

What is claimed is:

1. A method of removing a connector, which is mounted on a board, from the board by applying a solder to terminal leads extending from a connector body, the method comprising:
a step of attaching a heat transfer part to said connector by insertion;
a step of heating the terminal leads by heating said heat transfer part and melting the solder by heat; and
a step of separating said connector from said board.

2. The method of removing a connector as claimed in claim 1, wherein said connector is surface-mounted on said board.

3. The method of removing a connector as claimed in claim 1, wherein said connector is inserted into and mounted to said board.

4. A removing tool used for removing a connector from a board, the connector being mounted to the board by soldering lead terminals extending from a connector body, the removing tool comprising:
a heat transfer part having a thermal conductivity and being inserted into and attached to said connector body; and
a heating device that heats said heat transfer part.

5. The removing tool as claimed in claim 4, wherein said heating device is a hot-air heater.

6. The removing tool as claimed in claim 4, wherein said heating device has a planar shape substantially equal to a planar shape of said connector body.

7. The removing tool as claimed in claim 4, wherein a heat absorbing fin, which is heated by said heating device, is provided in a portion of said heat transfer part opposite to a side, which is inserted into and attached to said connector body.

8. The removing tool as claimed in claim 4, wherein said heating device includes a plurality of heaters and temperature controller for adjusting a temperature of each of the heaters.
